(19) United States
(12) Patent Application Publication
(10) Pub. No.: US 2008/0285942 A1
(43) Pub. Date: Nov. 20, 2008

(54) HOME NETWORK APPARATUS

(75) Inventor: Shinji YAMADAJI, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/769,378

(22) Filed: Jun. 27, 2007

(30) Foreign Application Priority Data
Jun. 29, 2006 (JP) 2006-180264

(51) Int. Cl. H04N 5/91

(52) U.S. Cl. 386/83; 386/E05.003

(57) ABSTRACT

A home network system includes a home network apparatus, and a recording reservation information-sending apparatus and recording/reproducing apparatuses which are connected to the home network apparatus. The home network apparatus has an interface circuit through which the auto-home network apparatus is connected to an Internet having a mail server and a recording reservation information-sending apparatus connected thereto, and a home network. The home network apparatus monitors recording reservation information sent to either of the recording/reproducing apparatus within a home network system, and instructs the recording/reproducing apparatus to perform the recording reservation, for example, if the recording/reproducing apparatus is in a wake-up state when being an object for recording reservation.

The present application is based on Japanese patent application No. 2006-180264, the entire contents of which are incorporated herein by reference.

### BACKGROUND

1. Field

One embodiment of the invention relates to a home network apparatus which communicates with the Internet, and which communicates with a plurality of apparatuses connected to a home network.

2. Description of the Related Art

For example, a program recording-reserving method in which when judging that a transmission capacity of a home network can be ensured, a network reservation information-managing apparatus instructs a reservation receiving apparatus to set a program viewing reservation or a program recording reservation, and a recording apparatus is activated in accordance with this setting is known as conventional one. This program recording-reserving method, for example, is disclosed in the Japanese Patent Kokai No. 2003-258802. According to this method, a transmission rate in a phase of a recording reservation can be determined in accordance with a band of a network, and a failure in recording or viewing accompanying a shortage of the transmission capacity can be prevented.

However, the conventional program reserving method is utilized to merely check the transmission capacity of the network, and thus the apparatus for which the recording reservation is performed cannot be checked to the extent relating to whether a power source thereof is in an ON state or in an OFF state.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing a connection form in a network system according to an embodiment of the invention;

FIG. 2 is an exemplary block diagram showing a detailed configuration of a home network apparatus according to the embodiment of the invention;

FIG. 3 is an exemplary block diagram showing a detailed configuration of a recording reservation-sending apparatus according to the embodiment of the invention;

FIG. 4 is an exemplary block diagram showing a detailed configuration of a recording/reproducing apparatus according to the embodiment of the invention;

FIG. 5 is an exemplary flow chart showing an operation of the home network apparatus according to the embodiment of the invention;

FIG. 6 is an exemplary flow chart showing detailed processing in Steps S111 and S112 shown in FIG. 5; and

FIG. 7 is an exemplary flow chart showing, another detailed processing in Steps S111 and S112 shown in FIG. 5.

### DETAILED DESCRIPTION OF PREFERRED EMBODIMENTS

Various embodiments according to the invention will be described hereinafter with reference to the accompanying drawings. In general, according to one embodiment of the invention, there is provided a home network apparatus, including: a monitoring portion for monitoring input of recording reservation information; a detecting portion for detecting a power source turn-ON/OFF state of an object apparatus specified in accordance with the recording reservation information; and an information sending portion for sending the recording reservation information in accordance with a detection result obtained in the detecting portion.

In addition, according to a further embodiment of the invention, there is provided a home network apparatus, including: a monitoring portion for monitoring input of recording reservation information; an analyzing portion for analyzing the recording reservation information, thereby determining an object apparatus for recording reservation; a detecting portion for detecting a power source turn-ON/OFF state of the object apparatus; an information sending portion for sending the recording reservation information in accordance with a detection result obtained in the detecting portion; and a command sending portion for, when the detecting portion detects that a power source of the object apparatus is in an OFF state, sending a power source turn-ON command to the object apparatus.

In addition, according to a still further embodiment of the invention, there is provided a home network apparatus, including: a monitoring portion for monitoring input of recording reservation information; an analyzing portion for analyzing the recording reservation information, thereby determining an object apparatus for recording reservation; a detecting portion for detecting a power source turn-ON/OFF state of the object apparatus; an information sending portion for sending the recording reservation information in accordance with a detection result obtained in the detecting portion; a command sending portion for, when the detecting portion detects that a power source of the object apparatus is in an OFF state, sending a power source turn-ON command to the object apparatus; and a recording reservation completion-detecting portion for detecting that the recording reservation is set in the object apparatus in accordance with the recording reservation information.

According to the home network apparatus of the invention, it is possible to monitor a state of any of apparatuses connected to a home network, and thus is possible to reduce a restriction in recording reservation.

[Construction of Network System]

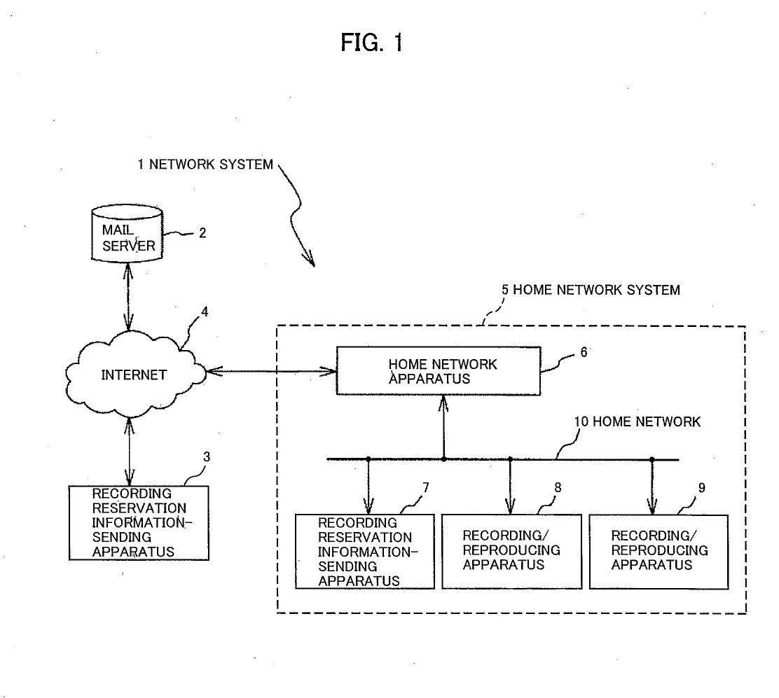

FIG. 1 shows a network system according to an embodiment of the invention. The network system 1 is constructed such that a home network system 5 is connected to the Internet 4 having a mail server 2 and a recording reservation information-sending apparatus 3 connected thereto.

The mail server 2 is a computer for executing processing for transmitting/receiving an e-mail on the Internet 4.

The recording reservation information-sending apparatus 3, for example, is a note type personal computer which a user who utilizes the home network system 5 possesses. Also, the recording reservation information-sending apparatus 3 is connected to the home network system 5 through the Internet 4 from a place where the user is out, or the like.

[Construction of Home Network System]

The home network system 5 includes a home network apparatus 6 which is connected to the Internet 4, and a home network 10 such as a LAN, and the recording reservation information-sending apparatus 7 and the recording/reproducing apparatuses 8 and 9 which are all connected to the home network 10. The recording/reproducing apparatus 8 and 9 is an object apparatus for recording reservation.

[Configuration of Home Network Apparatus]

The home network apparatus 6 has a function of communicating with the Internet 4, a function of monitoring operational states such as ON/OFF of power sources of the recording reservation information-sending apparatus 7, and the recording/reproducing apparatuses 8 and 9, and performing ON/OFF control for these power sources, a function of intermediating a communication established between the apparatuses connected to the home network apparatus 6, a function of monitoring an operational state representing whether or not the recording reservation can be received, and the like.

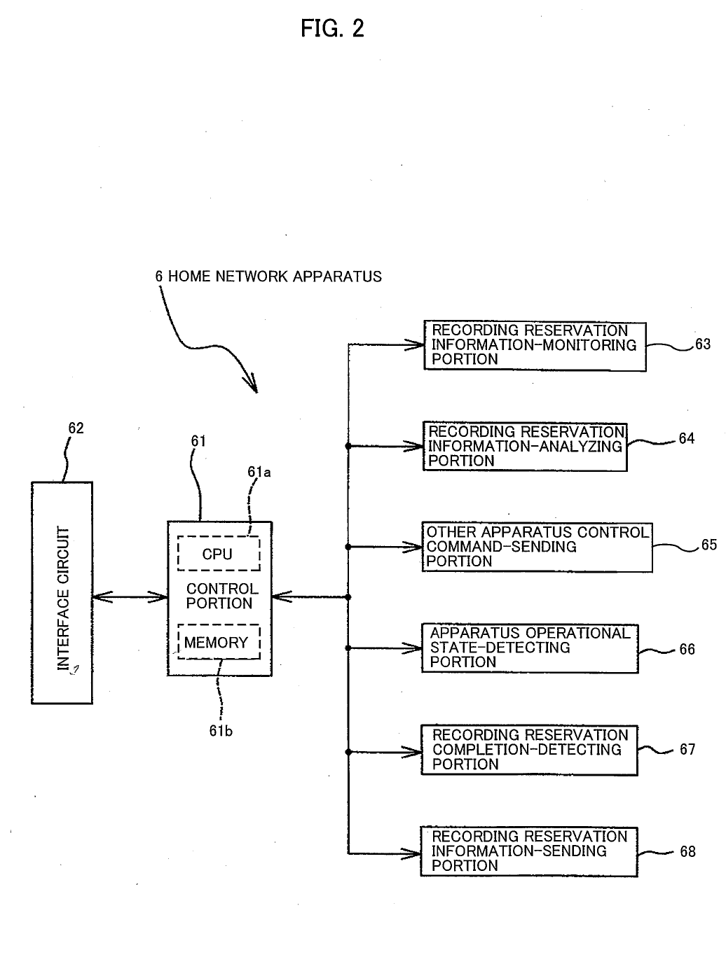

FIG. 2 shows a detailed configuration of the home network apparatus. The home network apparatus 6 is configured by mainly including a control portion 61, having a CPU 61a and a memory 61b, for controlling the entire home network apparatus 6. An interface circuit 62, a recording reservation information-monitoring portion 63 serving as a monitoring portion, a recording reservation information-analyzing portion 64 serving as an analyzing portion, an other apparatus control command-sending portion 65 serving as a command sending portion, an apparatus operational state-detecting portion 66 serving as a detecting portion, a recording reservation completion-detecting portion 67, and a recording reservation information-sending portion 68 serving as an information sending portion are all connected to the control portion 61.

The interface circuit 62 has a circuit structure for establishing a communication with each of the recording reservation information-sending apparatus 7, and the recording/reproducing apparatuses 8 and 9, and receives a recording reservation information through the Internet 4 from the recording reservation information-sending apparatus 3.

The recording reservation information-monitoring portion 63 has a structure for monitoring recording reservation information within the home network system 5.

The recording reservation information-analyzing portion 64 has a structure for analyzing the recording reservation information relating to from which apparatus to which apparatus the recording reservation will be performed, in which time zone which program will be reserved in recording, and so forth.

The other apparatus control command-sending portion 65 has a structure for transmitting a wake-up command (power source turn-ON command) from the recording reservation information-sending apparatus 7 to either of the recording/reproducing apparatus 8 and 9, thereby preparing for start of the recording reservation.

The apparatus operational state-detecting portion 66 has a structure for monitoring whether or not an apparatus as an object for control is activated.

The recording reservation completion-detecting portion 67 is structured to be able to detect whether or not the recording reservation is completed in accordance with the recording reservation information within the home network system 5.

The recording reservation information-sending portion 68 has a structure for sending the recording reservation information to specified one of the recording/reproducing apparatuses 8 and 9 for performing the recording in accordance with the recording reservation.

[Configuration of Recording Reservation Information-Sending Apparatus]

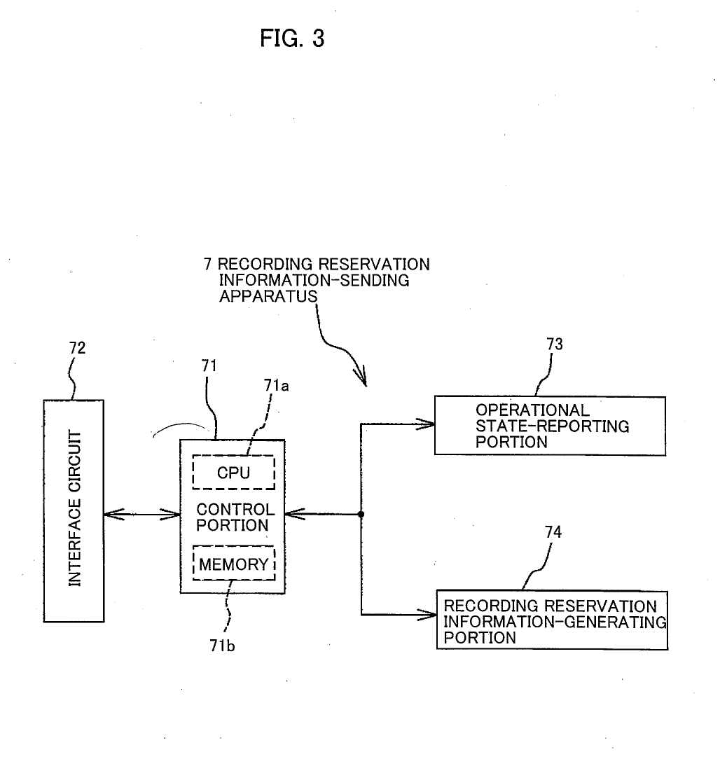

FIG. 3 is a block diagram showing a detailed configuration of the recording reservation information-sending apparatus. The recording reservation information-sending apparatus 7 has a configuration for generating the recording reservation information, and sending the resulting recording reservation information to one of the recording/reproducing apparatuses 8 and 9. The recording reservation information-sending apparatus 7 can adopt a configuration using a personal computer in addition to a configuration using dedicated circuits.

The recording reservation information-sending apparatus 7 is configured by mainly including a control portion 71, having a CPU 71a and a memory 71b, for controlling the entire recording reservation information-sending apparatus 7. An interface circuit 72, an operational state-reporting portion 73, and a recording reservation information-generating portion 74 are all connected to the control portion 71.

The interface circuit 72 has a circuit structure for establishing a communication between the home network apparatus 6 and the auto-recording reservation information-sending apparatus 7 through the home network 10.

The operational state-reporting portion 73 has a structure for reporting an operational state of the recording reservation information-sending apparatus 7 to the home network apparatus 6 through the interface circuit 72 and the home network 10.

The recording reservation information-generating portion 74 has a structure for generating the recording reservation information for the apparatus for performing the recording, for example, the recording/reproducing apparatus 8.

[Configuration of Recording/Reproducing Apparatus]

While the recording/reproducing apparatuses 8 and 9 serve to record broadcasting programs in their storage media in accordance with recording reservations, respectively, since both the recording/reproducing apparatuses 8 and 9 have the same configuration, only the recording/reproducing apparatus 8 will now be described for the sake of simplicity.

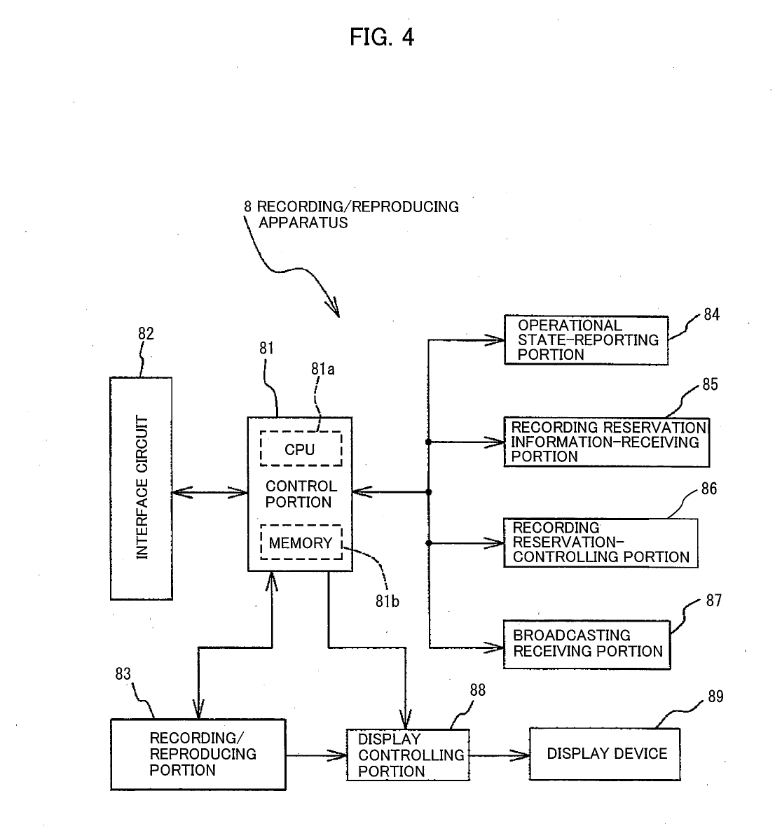

FIG. 4 shows a detailed configuration of the recording/reproducing apparatus. The recording/reproducing apparatus 8 is configured by mainly including a control portion 81, having a CPU 81a and a memory 81b, for controlling the entire recording/reproducing apparatus 8. An interface circuit 82, a recording/reproducing portion 83, an operational state-reporting portion 84, a recording reservation information-receiving portion 85, a recording reservation-controlling portion 86, a broadcasting receiving portion 87, and a display controlling portion 88 are all connected to the control portion 81. Moreover, a display device 89 such as a liquid crystal display device is connected to the display controlling portion 88.

The interface circuit 82 has a circuit structure for establishing a communication between the home network apparatus 6 and the recording/reproducing apparatus 8 through the home network 10.

The recording/reproducing portion 83 has a structure for recording a broadcasting program in its storage medium such as a hard disc (HD), and reproducing a program recorded in its storage medium.

The operational state-reporting portion 84 has a structure for reporting an ON/OFF state of a power source of the recording/reproducing apparatus 8 to the home network apparatus 6 through the interface 82.

The recording reservation information-receiving portion 85 has a structure for receiving the recording reservation information from the home network apparatus 6.

The display controlling portion 88 is structured so as to output a video output from the recording/reproducing portion 83 to the display device 89 and so as to output an audio signal to a speaker (not shown) belonging to the display device 89.

The recording reservation-controlling portion 86 has a circuit structure for carrying out a set recording reservation by controlling both the broadcasting receiving portion 87 and the recording/reproducing portion 83.

The broadcasting receiving portion 87 includes a tuner for receiving a VHF broadcasting, a UHF broadcasting, a satellite broadcasting or the like, and has a circuit structure for outputting a video signal and an audio signal about a selected program.

[Operation of Home Network Apparatus]

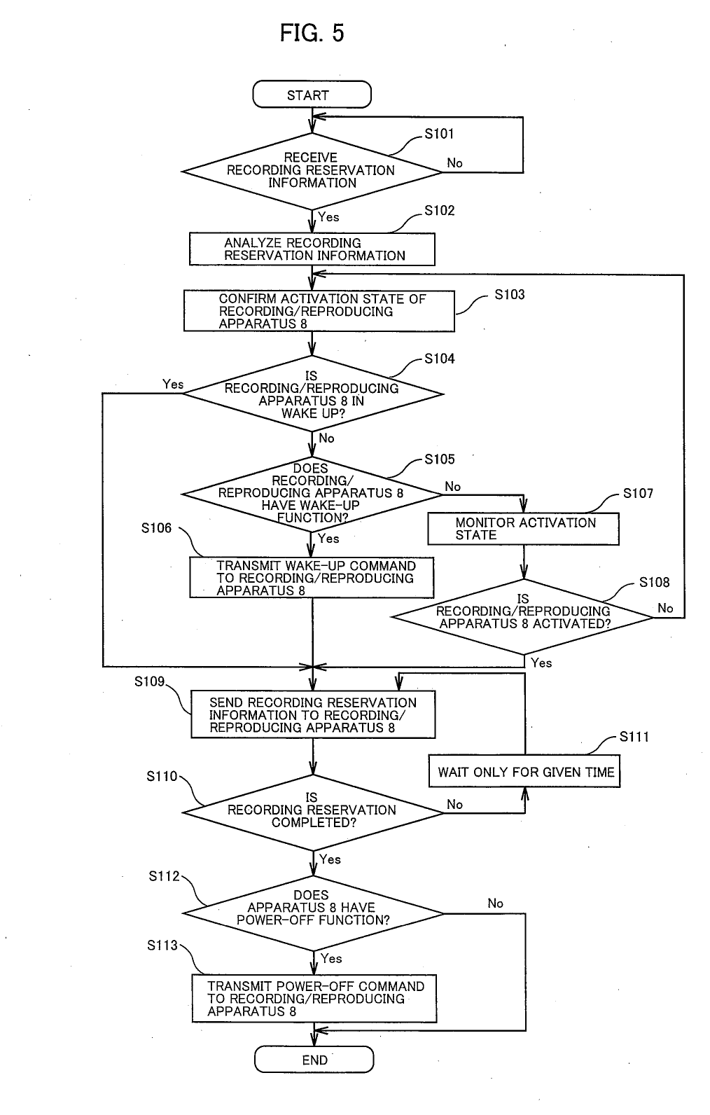

Next, an operation of the home network apparatus 6 will now be described. FIG. 5 is a flow chart showing an operation of the home network apparatus. A description will be given hereinafter with respect to the case where the recording reservation information-sending apparatus 7 performs the recording reservation for the recording/reproducing apparatus 8.

Firstly, the recording reservation information-generating portion 74 of the recording reservation information-sending apparatus 7 generates the recording reservation information, and the control portion 71 sends the resulting recording reservation information to the home network apparatus 6 through the interface circuit 72.

The recording reservation information-monitoring portion 63 of the home network apparatus 6 monitors the recording reservation information sent from the recording reservation information-sending apparatus 7, and judges whether or not the recording reservation information sent from the recording reservation information-sending apparatus 7 is received (Step S101). When the recording reservation information-monitoring portion 63 judges that the recording reservation information sent from the recording reservation information-sending apparatus 7 is received (Step S101: YES), the control portion 61 operates the recording reservation information-analyzing portion 64, so that the recording reservation information-analyzing portion 64 analyzes the contents of the recording reservation information (Step S102), and confirms the activation state of the recording/reproducing apparatus 8 (Step S103). Here, the activation means either the case where the user manually turns ON the power source of the recording/reproducing apparatus 8 or the case where the power source is automatically turned ON at the daily specified time in accordance with update of electronic program guide (EPG) data or a time signal, that is, a state in which the recording reservation or the like is received through the Internet 4 in the phase of the ON state of the power source.

The recording reservation information-analyzing portion 64 monitors whether or not the recording reservation information flows on the home network 10, and when the recording reservation information exists in the home network 10, analyzes the recording reservation information relating to from which apparatus to which apparatus the recording reservation will be performed, in which time zone which program will be reserved in recording, and so forth. As a result, the recording reservation information-analyzing portion 64 analyzes that the recording reservation information concerned is one sent from the recording reservation information-sending apparatus 7 to the recording/reproducing apparatus 8.

Next, the control portion 61 judges whether or not the recording/reproducing apparatus 8 is in wake up (that is, the power source thereof is in the ON state) (Step S104). When the control portion 61 judges that the recording/reproducing apparatus 8 is in wake up (Step S104: YES), the operation proceeds to the processing in Step S109.

When the recording/reproducing apparatus 8 is not activated (that is, when the power source thereof is in the OFF state), the home network apparatus 6 refers a function list in memory 61b to retrieve whether or not the apparatus having a wake-up function exists in the home network system 5.

The function list of the apparatus is one in which information on presence or absence of the wake-up function, a media access control (MAC) address and an Internet protocol (IP) address required to activate the apparatus, ID information, such as a pet name of the apparatus, inherent in the apparatus, and the like are described. Also, the home network apparatus 6 is connected to a personal computer by a broad-band router, a network, response HDD recorder or the like in order to set the function list of the apparatus via a browser. Here, the function list of the apparatus may be set by using a dedicated user interface (UI) instead of using the browser.

A PING command determined in accordance with a transmission control protocol (TCP)/IP is transmitted to the recording/reproducing apparatus 8 and 9 as a target, and the operational state of the recording/reproducing apparatus 8 and 9 is periodically reported from the operational state-reporting portion 84 to the home network apparatus 6, thereby making it possible to judge whether the power source of the recording/reproducing apparatus 8 and 9 is in the ON state or in the OFF state. It should be noted that the command is not limited to the PING command in this invention, and any other suitable command is available as long as the operation can be confirmed in accordance with it. Information on the operational situation and the activation situation of the apparatus on the home network 10 which are confirmed in the manner described above is held in the home network apparatus 6.

On the other hand, when judging in Step S104 that the recording/reproducing apparatus 8 is not in wake up (Step S104: NO), the home network apparatus 6 judges whether or not the recording/reproducing apparatus 8 has the wake-up function (Step S105). When the home network apparatus 6 judges that the recording/reproducing apparatus 8 has the wake-up function (Step S105: YES), the other apparatus control command-sending portion 65 transmits the wake-up command to the recording/reproducing apparatus 8 (Step S106).

On the other hand, when the home network apparatus 6 judges that the recording/reproducing apparatus 8 has no wake-up function (Step S105: NO), the apparatus operational state-detecting portion 66 of the home network apparatus 6 monitors the activation state of the recording/reproducing apparatus 8 (Step S107), and judges whether or not the recording/reproducing apparatus 8 is activated (Step S108). When the apparatus operational state-detecting portion 66 judges that the recording/reproducing apparatus 8 is activated (Step S108: YES), the recording reservation information-sending portion 68 sends the recording reservation information to the recording/reproducing apparatus 8 (Step S109), and instructs the recording/reproducing apparatus 8 to perform the recording reservation. On the other hand, when the apparatus operational state-detecting portion 66 judges that the recording/reproducing apparatus 8 is not activated (Step S108: NO), the operation returns back to the processing in Step S103, and the processing in and after the processing in Step S103 is re-executed.

In the recording/reproducing apparatus 8, the recording reservation information-receiving portion 85 receives the recording reservation information through the interface circuit 82 and the control portion 81, the control portion 81, the recording reservation-controlling portion 86, the broadcasting recording portion 87 and the recording/reproducing portion 83 are activated in accordance with the recording reservation information, and the broadcasting program is recorded in the recording/reproducing portion 83.

When the recording reservation completion-detecting portion 67 of the home network apparatus 6 detects the completion of the recording reservation performed by the recording/reproducing apparatus 8 (Step S110: YES), the home network apparatus 6 judges whether or not the recording/reproducing apparatus 8 has a power-OFF function (Step S112). When judging that the recording/reproducing apparatus 8 has the power-OFF function (Step S112: YES), the home network apparatus 6 transmits a power-OFF command to the recording/reproducing apparatus 8 (Step S113), thereby turning OFF the power source of the recording/reproducing apparatus 8.

On the other hand, when the recording reservation completion-detecting portion 67 does not judge in Step S110 the completion of the recording reservation (Step S110: NO), after wait only for a given period of time (Step S111), the operation returns back to the processing in Step S109, and the recording reservation is performed again. In addition, when the home network apparatus 6 judges that the recording/reproducing apparatus 8 has no power-OFF function (Step S112: NO), the recording/reproducing apparatus 8 is left in the state, that is, in the ON state of the power source.

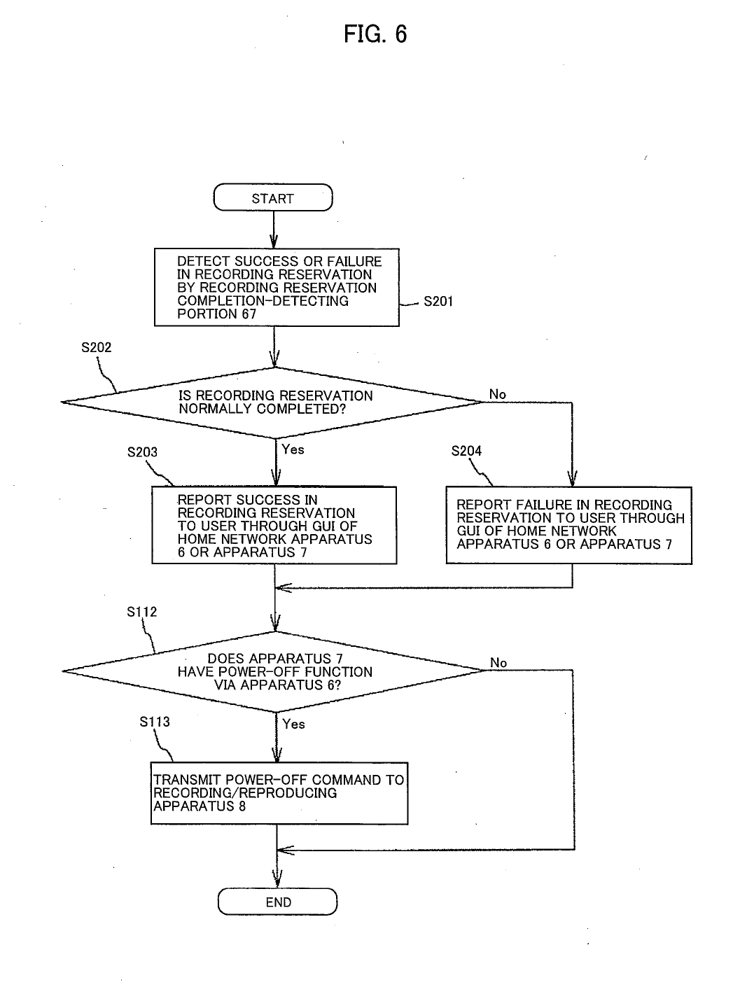

FIG. 6 shows detailed processing in Steps S110 to S113 of FIG. 5. The detailed processing is executed through participation of the recording reservation completion-detecting portion 67 of the home network apparatus 6 therein. Firstly, the recording reservation completion-detecting portion 67 detects whether or not the recording/reproducing apparatus 8 succeeds in the recording reservation (Step S201). When it is judged that the recording reservation is normally completed in accordance with the detection results (Step S202: YES), information on the success in the recording reservation is reported either to the home network apparatus 6 or to the recording reservation information-sending apparatus 7 through a graphical user interface (GUI) of the home network apparatus 6 and is displayed on a display device (not shown) of the home network apparatus 6 or the recording reservation information-sending apparatus 7, thereby reporting the success or failure in the recording reservation to the user (Step S203). On the other hand, when the home network apparatus 6 has the function of transmitting an e-mail, the success of failure in the recording reservation may be reported to a mail address which the user previously specified through the mail server 2.

When even if the recording reservation is performed the preset number of times in Step S202, it is judged that the recording reservation is not normally completed (Step S202: NO), information on the failure in the recording reservation is displayed on the display device of the home network apparatus 6 through the GUI of the home network apparatus 6, thereby reporting the failure in the recording reservation to the user (Step S204). In addition, an alert on the failure in the recording reservation may be issued to the recording reservation information-sending apparatus 7, and the recording reservation information-sending apparatus 7 may report the failure in the recording reservation to the user through the GUI or the like.

After completion of the processing in Steps S203 and S204, the processing in Steps S112 and S113 which is previously described with reference to FIG. 5 is executed, and the processing for the recording reservation is completed.

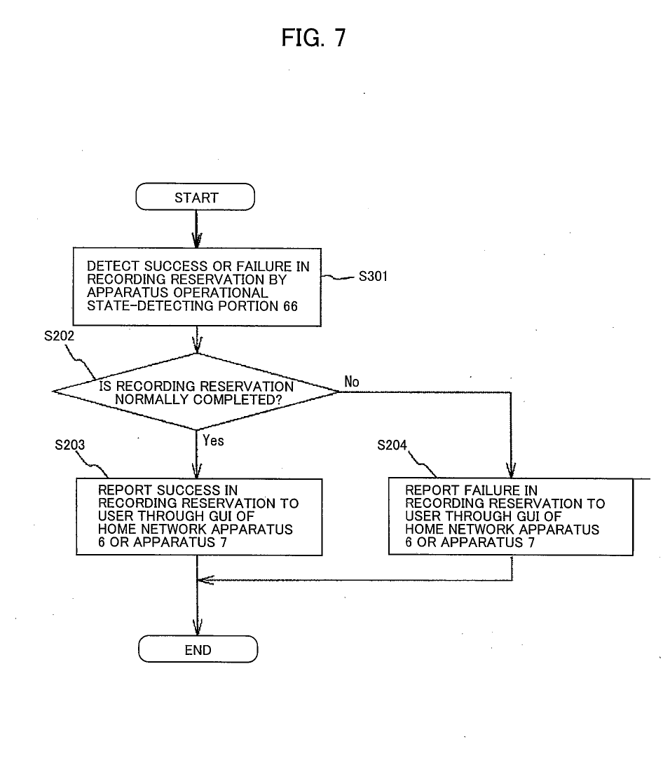

FIG. 7 shows another detailed processing in Steps S110 to S113 of FIG. 5. The another detailed processing is executed through the participation of the apparatus operational state-detecting portion 66 of the home network apparatus 6 therein. Firstly, the apparatus operational state-detecting portion 66 detects whether or not the recording/reproducing apparatus 8 succeeds in the recording reservation (Step S301). When it is judged that the recording reservation is normally completed in accordance with the detection results (Step S202: YES), information on the success in the recording reservation is reported either to the home network apparatus 6 or to the recording reservation information-sending apparatus 7 through the GUI of the home network apparatus 6, and is displayed on the display device of the home network apparatus 6 or the recording reservation information-sending apparatus 7, thereby reporting the success in the recording reservation to the user (Step S203).

On the other hand, when it is judged in Step S202 that the recording reservation is not normally completed (Step S202: NO), information on the failure in the recording reservation is reported either to the home network apparatus 6 or to the recording reservation information-sending apparatus 7 through the GUI of the home network apparatus 6, and is displayed on the display device of the home network apparatus 6 or the recording reservation information-sending apparatus 7, thereby reporting the failure in the recording reservation to the user (Step S204).

According to the above-mentioned embodiment of the invention, the following effects are offered.

(i) Since the home network apparatus 6 can monitor the operational state of the recording/reproducing apparatus 8 and 9, for example, even when the recording reservation information-sending apparatus 7 can not directly perform the recording reservation for the recording/reproducing apparatus 8 because the power source of the recording/reproducing apparatus 8 is in the OFF state, the home network apparatus 6 can perform the recording reservation.

(ii) Since the recording reservation information sent from the recording reservation information-sending apparatus 7 within the home network system 5 can be managed by the home network apparatus 6, and the information relating to whether the recording reservation for the recording/reproducing apparatus 8 and 9 is normally completed or failed can be reported to the user, the user can readily grasp the success or failure in the recording reservation.

(iii) Since when the recording/reproducing apparatus 8 and 9 has the wake-up function, the home network apparatus 6 can transmit the wake-up command to the recording/reproducing apparatus 8 and 9, thereby performing the recording reservation for the recording/reproducing apparatus 8 and 9, it is unnecessary for the user to manage ON/OFF of the power source of the recording/reproducing apparatus 8 and 9.

(iv) Since the home network apparatus 6 can take therein the reservation information from the recording reservation information-sending apparatus 3 in a place where the user is out or the like through the Internet 4, the availability of the recording reservation can be enhanced. In this case, the home network apparatus 6 receives temporarily the recording reservation information, and performs the recording reservation for the recording/reproducing apparatus 8 and 9.

It should be noted that the invention is not intended to be limited to the above-mentioned embodiment, and the various changes thereof can be made by those skilled in the art without departing from or changing the technical idea of the invention.

For example, the home network apparatus 6 may have a configuration of responding to a mail reservation as well. In this case, the home network apparatus 6 may take therein periodically the recording reservation information from the mail server, and may perform the recording reservation for the recording/reproducing apparatus 8 and 9 by utilizing the same method as that of the foregoing.

In addition, the home network apparatus 6 may be installed in any one of the recording reservation information-sending apparatus 7, and the recording/reproducing apparatuses 8 and 9.

What is claimed is:

1. A home network apparatus, comprising:
a monitoring portion for monitoring input of recording reservation information;
a detecting portion for detecting a power source turn-ON/OFF state of an object apparatus specified in accordance with the recording reservation information; and
an information sending portion for sending the recording reservation information in accordance with a detection result obtained in the detecting portion.

2. A home network apparatus according to claim 1, wherein when the detecting portion detects that no power source of the object apparatus is turned ON, the information sending portion sends no recording reservation information.

3. A home network apparatus according to claim 2, wherein when the detecting portion detects that the power source of the object apparatus is turned ON, the information sending portion sends the recording reservation information.

4. A home network apparatus according to claim 1, wherein the monitoring portion monitors the recording reservation information inputted either from an external recording reservation information-sending apparatus or from an external mail server.

5. A home network apparatus according to claim 4, wherein the monitoring portion, the detecting portion, and the information sending portion are included in the recording reservation information-sending apparatus.

6. A home network apparatus, comprising:
a monitoring portion for monitoring input of recording reservation information;
an analyzing portion for analyzing the recording reservation information, thereby determining an object apparatus for recording reservation;
a detecting portion for detecting a power source turn-ON/OFF state of the object apparatus;
an information sending portion for sending the recording reservation information in accordance with a detection result obtained in the detecting portion; and
a command sending portion for, when the detecting portion detects that a power source of the object apparatus is in an OFF state, sending a power source turn-ON command to the object apparatus.

7. A home network apparatus according to claim 6, wherein after the command sending portion sends the power turn-ON command to the object apparatus, the information sending portion sends the recording reservation information.

8. A home network apparatus according to claim 6, wherein the monitoring portion monitors the recording reservation information inputted either from an external recording reservation information-sending apparatus or from an external mail server.

9. A home network apparatus according to claim 6, wherein the detecting portion detects the power source turn-ON/OFF state of the object apparatus by sending a PING command to the object apparatus.

10. A home network apparatus according to claim 6, wherein the analyzing portion analyzes the recording reservation information, acquires at least one of a broadcasting channel, a recording time, and a recording quality as a recording reservation content, and determines an object apparatus for recording reservation in accordance with the recording reservation content.

11. A home network apparatus according to claim 8, wherein the monitoring portion, the analyzing portion, the detecting portion, the information sending portion, and the command sending portion are included in the recording reservation information-sending apparatus.

12. A home network apparatus, comprising:
a monitoring portion for monitoring input of recording reservation information;
an analyzing portion for analyzing the recording reservation information, thereby determining an object apparatus for recording reservation;
a detecting portion for detecting a power source turn-ON/OFF state of the object apparatus;
an information sending portion for sending the recording reservation information in accordance with a detection result obtained in the detecting portion;
a command sending portion for, when the detecting portion detects that a power source of the object apparatus is in an OFF state, sending a power source turn-ON command to the object apparatus; and
a recording reservation completion-detecting portion for detecting that the recording reservation is set in the object apparatus in accordance with the recording reservation information.

13. A home network apparatus according to claim 12, wherein after the command sending portion sends the power turn-ON command to the object apparatus, the information sending portion sends the recording reservation information.

14. A home network apparatus according to claim 12, wherein when the recording reservation completion-detecting portion detects that the recording reservation is completed, the command sending portion transmits a power-OFF command to the object apparatus.

15. A home network apparatus according to claim 12, wherein when the recording reservation is completed, the recording reservation completion-detecting portion reports the completion of the recording reservation to at least an apparatus which sends the recording reservation information.

16. A home network apparatus according to claim 12, wherein the recording reservation completion-detecting portion has a displaying portion for, when the recording reservation completion-detecting portion detects that the recording reservation is completed, displaying thereon information on the completion of the recording reservation.

17. A home network apparatus according to claim 12, wherein when the recording reservation is failed, the recording reservation completion-detecting portion reports a failure in the recording reservation to at least an apparatus which sends the recording reservation information.

18. A home network apparatus according to claim 12, wherein when the recording reservation completion-detecting portion has a displaying portion for, when the recording reservation completion-detecting portion detects that the recording reservation is failed, displaying thereon information on the failure in the recording reservation.

19. A home network apparatus according to claim 12, wherein the analyzing portion analyzes the recording reservation information, acquires at least one of a broadcasting channel, a recording time, and a recording quality as a recording reservation content, and determines an object apparatus for recording reservation in accordance with the recording reservation content.
